(19) United States
(12) Patent Application Publication
(10) Pub. No.: US 2024/0280599 A1
(43) Pub. Date: Aug. 22, 2024

(54) MATERIAL TESTING SYSTEMS WITH CUSTOMIZABLE DATA PARSERS AND WORKFLOW FIELD MAPPINGS

(71) Applicant: Illinois Tool Works Inc., Glenview, IL (US)

(72) Inventors: Jason Morse, Grafton, MA (US); Scott Nicol, Acton, MA (US); Daniel Vincent Caesar, South Boston, MA (US)

(21) Appl. No.: 18/444,923

(22) Filed: Feb. 19, 2024

Related U.S. Application Data
(60) Provisional application No. 63/447,182, filed on Feb. 21, 2023.

(51) Int. Cl. G01N 35/00

(52) U.S. Cl. CPC G01N 35/00732; G01N 2035/00851; G01N 2035/00861; G01N 2035/0091

(57) ABSTRACT

Described herein are examples of material testing systems that allow users to select one or more customizable data parsers (from amongst several customizable data parsers) when configuring a workflow for setup, execution, and/or analysis of a test method on a material testing machine. Thereafter, when a piece of data is imported by an importation device during operation of the workflow, the selected data parser(s) can separate (or parse) out several smaller data portions from the imported data. The several smaller data portions can be mapped to different input fields and/or used to set several different (e.g., input field associated) parameters of the workflow at the same time. In this way, a material testing workflow can be made far more efficient than in conventional systems where imported data can only be used to set a single workflow parameter (and/or fill a single input field).

### CROSS REFERENCE TO RELATED APPLICATIONS

This application claims the benefit of, and priority to, U.S. Provisional Patent Application No. 63/447,182, entitled “Material Testing Systems with Customizable Data Parsers and Workflow Field Mappings,” filed Feb. 21, 2023, the entire contents of which are hereby incorporated by reference.

### TECHNICAL FIELD

The present disclosure generally relates to material testing systems and, more particularly, to material testing systems with customizable data parsers and workflow field mappings.

### BACKGROUND

Material testing machines are used to test the properties (e.g., tensile/compressive strength) of various material specimens. The particular method of testing (a.k.a. test method) may vary from material specimen to material specimen. A computing device in communication with the material testing machine may guide a user through a workflow to setup, execute, and analyze the results of each test method.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to material testing systems with customizable data parsers and workflow field mappings, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example material testing system, in accordance with aspects of this disclosure.

FIG. 2 is a block diagram of the material testing system of FIG. 1, in accordance with aspects of this disclosure.

FIG. 3 is a flowchart illustrating an example state progression of a material testing workflow, in accordance with aspects of this disclosure.

FIG. 4 is a flowchart illustrating example operation of a testing process of the material testing system of FIG. 2, in accordance with aspects of this disclosure.

FIG. 5 is a flowchart illustrating example operation of a parsing configuration setup process of the testing process of FIG. 4, in accordance with aspects of this disclosure.

FIG. 6 is a flowchart illustrating example operation of a workflow setup process of the testing process of FIG. 4, in accordance with aspects of this disclosure.

FIG. 7 is a flowchart illustrating example operation of a workflow execution process of the testing process of FIG. 4, in accordance with aspects of this disclosure.

FIG. 8 is a flowchart illustrating example operation of a tag printing process of the testing process of FIG. 4, in accordance with aspects of this disclosure.

FIGS. 9a-9b depict example parsing configuration graphical user interfaces (GUIs) that might be output during the parsing configuration setup process of FIG. 5, in accordance with aspects of this disclosure.

FIG. 10 depicts an example workflow setup GUI that might be output during the workflow setup process of FIG. 6, in accordance with aspects of this disclosure.

FIG. 11 depicts an example workflow GUI that might be output during the workflow execution process of FIG. 7, in accordance with aspects of this disclosure.

FIG. 12 depicts an example tag printing GUI that might be output during the tag printing process of FIG. 8, in accordance with aspects of this disclosure.

The figures are not necessarily to scale. Where appropriate, the same or similar reference numerals are used in the figures to refer to similar or identical elements. For example, reference numerals utilizing lettering (e.g., grip 124a, grip 124b) refer to instances of the same reference numeral that does not have the lettering (e.g., grips 124).

### DETAILED DESCRIPTION

Material testing workflows sometimes require an operator to enter several pieces of information to setup a test method for execution, analyze results of the test method, and/or report the results of the test method. However, manual entry of information relevant to the test method risks both data entry errors and delay. While some systems automatically import the information, it can be time consuming for operators to separately import each piece of information, especially when there are numerous pieces of information that need to be imported.

The disclosed example material testing systems use data importation devices to automatically import data. The disclosed example material testing systems additionally use data parsers to separate the imported data into several smaller portions of data. In this way, a single piece of imported data can encapsulate several different pieces of data. Once separated, the several smaller portions of data can be used to populate various input fields and/or set various testing parameters (e.g., variables) of the material testing workflow. In this way, a material testing workflow can be made far more efficient than in conventional systems where imported data can only be used to set a single workflow parameter (and/or fill a single input field). The example material testing systems may additionally allow for customization of the data parsers, and/or the use of different data parsers for different workflows and/or input fields/parameters, making the systems highly robust.

Some examples of the present disclosure relate to a material testing system, comprising: a material testing machine, comprising a test sensor, a test actuator, and a test controller configured to control the test actuator to conduct a test method; and a non-transitory computer readable medium comprising machine readable instructions which, when executed by a processor, cause the processor to: execute a material testing workflow configured to guide a user through setup, execution, or analysis of the test method of the material testing machine, in response to executing the material testing workflow, display, on a display screen, a first graphical user interface (GUI) associated with a first workflow state of the material testing workflow, the first GUI comprising a first plurality of input fields, identify one or more first input fields, of the first plurality of input fields, that are associated with at least one input field mapping, the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields, and in response to receiving a piece of data imported from a data importation device: separate the piece of data into the two or more data portions according to the one or more parsing rules of the parsing configuration, and populate the one or more first input fields based on the at least one input field mapping.

In some examples, the non-transitory computer readable medium further comprises machine readable instructions which, when executed by the processor, cause the processor to: during execution of the material testing workflow, use data populating the one or more first input fields to execute the test method on the material testing machine or analyze a result of the test method executed on the material testing machine. In some examples, the non-transitory computer readable medium further comprises machine readable instructions which, when executed by the processor, cause the processor to: in response to initiation of a parsing configuration setup process: provide, via the display screen, a second GUI through which a user can customize the parsing configuration, receive a first signal from one or more input devices of a user interface, the first signal being representative of a first user interaction with the second GUI, the first user interaction defining at least one parsing rule of the one or more parsing rules, and create or modify, in the non-transitory computer readable medium, based on the first user interaction, machine readable data representative of the parsing configuration and the one or more parsing rules.

In some examples, the non-transitory computer readable medium further comprises machine readable instructions which, when executed by the processor, cause the processor to: during the parsing configuration setup process, receive sample data imported from the data importation device, display, on the display screen, a representation of the sample data in the second GUI, the first user interaction with the second GUI comprising an interaction with the representation of the sample data displayed in the second GUI, and display, on the display screen, an annotation of the representation of the sample data in the second GUI in response to the first user interaction, the annotation being descriptive of the at least one parsing rule. In some examples, the non-transitory computer readable medium further comprises machine readable instructions which, when executed by the processor, cause the processor to: in response to initiation of a material testing workflow setup process: provide, via the display screen, a third GUI through which a user can setup the material testing workflow, receive a second signal from the one or more input devices, the second signal being representative of a second user interaction with the third GUI, the second user interaction defining the at least one input field mapping associated with the one or more first input fields of the material testing workflow, and create or modify, in the non-transitory computer readable medium, the material testing workflow and the at least one input field mapping based on the second user interaction.

In some examples, the non-transitory computer readable medium further comprises machine readable instructions which, when executed by the processor, cause the processor to: receive, via one or more input devices of a user interface, two or more user created data portions, combine the two or more user created data portions into one user created data portion using an inversion of the one or more parsing rules of the parsing configuration, and print, via a tag printer, a tag encoding the one user created data portion. In some examples, the parsing configuration comprises a first parsing configuration, the first parsing configuration being associated with one or more first expected formatting criteria, and the non-transitory computer readable medium further comprises machine readable instructions which, when executed by the processor, cause the processor to: in response to receiving the piece of data imported from the data importation device, verify that the piece of data complies with the one or more first expected formatting criteria of the first parsing configuration, in response to successfully verifying that the piece of data complies with the one or more first expected formatting criteria of the first parsing configuration, separate the piece of data into the two or more data portions and populate the one or more first input fields, and in response to unsuccessfully verifying that the piece of data complies with the one or more expected formatting criteria of the first parsing configuration, output a notification via the user interface or identify a second parsing configuration comprising second expected formatting criteria to which the piece of data complies.

Some examples of the present disclosure relate to a material testing system, comprising: a data importation device; a material testing machine, comprising: a test sensor, a test actuator, and a test controller configured to control the test actuator to conduct a test method; a user interface; and a computing device configured for communication with the user interface, the material testing machine, and the data importation device, the computing device comprising: processing circuitry configured to: execute a material testing workflow configured to guide a user through setup, execution, or analysis of the test method of the material testing machine, in response to executing the material testing workflow, display, on a display screen of the user interface, a first graphical user interface (GUI) associated with a first workflow state of the material testing workflow, the first GUI comprising a first plurality of input fields, identify one or more first input fields, of the first plurality of input fields, that are associated with at least one input field mapping, the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields, and in response to receiving a piece of data imported from the data importation device: separate the piece of data into the two or more data portions according to the one or more parsing rules of the parsing configuration, and populate the one or more first input fields based on the at least one input field mapping.

In some examples, the data importation device comprises a barcode reader, a radio frequency identification (RFID) reader, a near field communication (NFC) reader, a short range ultra-high radio frequency reader, a camera, or a measuring device configured to measure a dimension of a specimen. In some examples, the processing circuitry is further configured to: in response to initiation of a parsing configuration setup process: provide, via the display screen, a second GUI through which a user can customize the parsing configuration, receive sample data imported from the data importation device, display, on the display screen, a representation of the sample data in the second GUI, receive a first signal from one or more input devices of the user interface, the first signal being representative of a first user interaction with the representation of the sample data displayed in the second GUI, the first user interaction defining at least one parsing rule of the one or more parsing rules, and display, on the display screen, an annotation of the representation of the sample data in the second GUI in response to the first user interaction, the annotation being descriptive of the at least one parsing rule.

In some examples, the at least one parsing rule comprises a start location and character length of a sub-string of the two or more data portions, a particular character that occurs before or after the sub-string, a particular character string that occurs before or after the sub-string, or a number of portions into which to separate the piece of imported data. In some examples, the processing circuitry is further configured to: in response to initiation of a material testing workflow setup process: provide, via the display screen, a third GUI through which a user can setup the material testing workflow, receive a second signal from the one or more input devices, the second signal being representative of a second user interaction with the third GUI, the second user interaction defining the at least one input field mapping associated with the one or more first input fields of the material testing workflow, and create or modify, in the memory circuitry, the material testing workflow and the at least one input field mapping based on the second user interaction.

In some examples, the processing circuitry is further configured to: during the material testing workflow setup process, in response to receiving one or more third signals from the one or more input devices, define the first workflow state of the material testing workflow and a second workflow state of the material testing workflow, the second workflow state being associated with a fourth GUI and a second plurality of input fields. In some examples, the system further comprises a tag printer in communication with the computing device, wherein the processing circuitry is further configured to: receive, via the one or more input devices, two or more user created data portions, combine the two or more user created data portions into one user created data portion using an inversion of the one or more parsing rules of the parsing configuration, and print, via the tag printer, a tag encoding the one user created data portion.

Some examples of the present disclosure relate to a method, comprising: executing, via processing circuitry of a computing device, a material testing workflow configured to guide a user through setup, execution, and analysis of a test method of a material testing machine, the computing device being in communication with the material testing machine, the material testing machine comprising a test sensor, a test actuator, and a test controller configured to control the test actuator to conduct a test method; in response to executing the material testing workflow, displaying, on a display screen of the user interface, a first graphical user interface (GUI) associated with a first workflow state of the material testing workflow, the first GUI comprising a first plurality of input fields, and the user interface being in communication with the computing device; identifying, via the processing circuitry, one or more first input fields, of the first plurality of input fields, that are associated with at least one input field mapping, the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields; and in response to receiving, at the computing device, a piece of data imported from a data importation device in communication with the computing device: separating the piece of data into the two or more data portions according to the one or more parsing rules of the parsing configuration, and populating the one or more first input fields based on the at least one input field mapping.

In some examples, the data importation device comprises a barcode reader, a radio frequency identification (RFID) reader, a near field communication (NFC) reader, a short range ultra-high radio frequency reader, a camera, or a measuring device configured to measure a dimension of a specimen. In some examples, the method further comprises using data populating the one or more first input fields to execute the test method on the material testing machine, or analyze a result of the test method executed on the material testing machine, during execution of the material testing workflow. In some examples, the method further comprises: in response to initiation of a parsing configuration setup process: providing, via the display screen, a second GUI through which a user can customize the parsing configuration, receiving, at the computing device, sample data imported from the data importation device, displaying, on the display screen, a representation of the sample data in the second GUI, receiving, at the computing device, a first signal from one or more input devices of the user interface, the first signal being representative of a first user interaction with the representation of the sample data displayed in the second GUI, the first user interaction defining at least one parsing rule of the one or more parsing rules, displaying, on the display screen, an annotation of the representation of the sample data in the second GUI in response to the first user interaction, the annotation being descriptive of the at least one parsing rule, and creating or modifying, in memory circuitry of the computing device, the parsing configuration and the one or more parsing rules based on the first user interaction.

In some examples, the method further comprises receiving, at the computing device, via the one or more input devices, two or more smaller user created data portions; combining, via the processing circuitry, the two or more smaller user created data portions into one larger user created data portion using an inversion of the one or more parsing rules of the parsing configuration; and printing, via a tag printer in communication with the communication device, a tag encoding the one larger user created data portion. In some examples, the parsing configuration comprises a first parsing configuration, the first parsing configuration being associated with one or more first expected formatting criteria, the method further comprising: in response to receiving, at the computing device, the piece of data imported from the data importation device, verify, via the processing circuitry, that the piece of data complies with the one or more first expected formatting criteria of the first parsing configuration, in response to successfully verifying that the piece of data complies with the one or more first expected formatting criteria of the first parsing configuration, separate the piece of data into the two or more data portions and populate the one or more first input fields, and in response to unsuccessfully verifying that the piece of data complies with the one or more expected formatting criteria of the first parsing configuration, output a notification via the user interface or identify a second parsing configuration comprising second expected formatting criteria to which the piece of data complies.

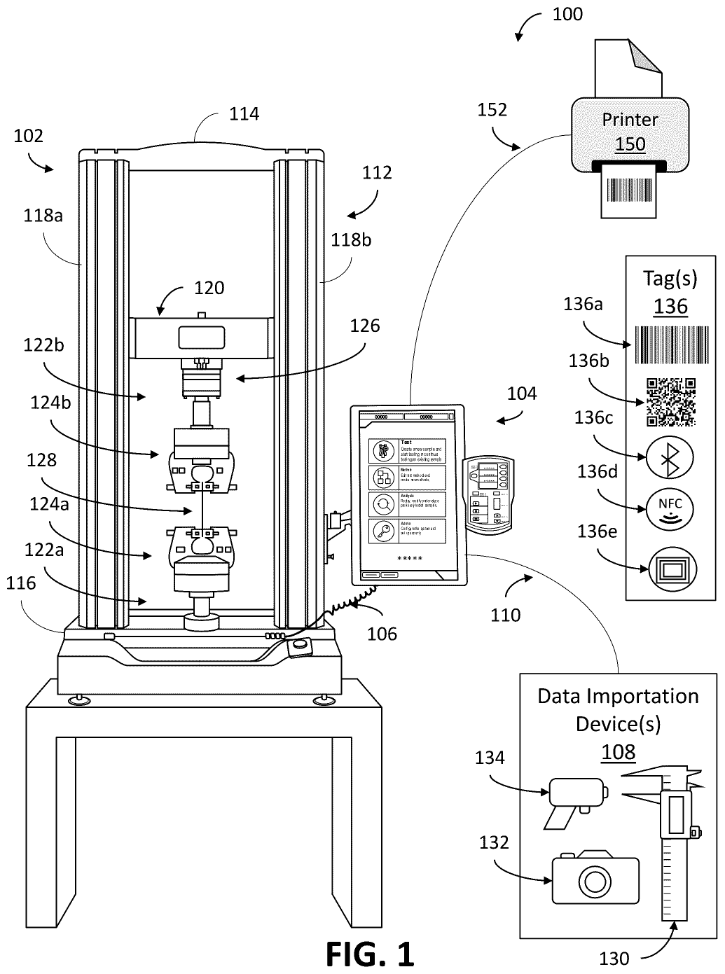

FIG. 1 shows an example material testing system 100. As shown, the material testing system 100 includes a material testing machine 102 (also known as a universal testing machine), a computing system 104 connected to the material testing machine 102 through cable 106, one or more data importation devices 108 connected to the computing system 104 through cord 110, and a tag printer 150 connected to the computing system 104 through line 152. While shown as being physically connected, in some examples, the connections between the computing system 104, material testing machine 102, data importation device 108, and/or printer 150 may be wireless rather than wired.

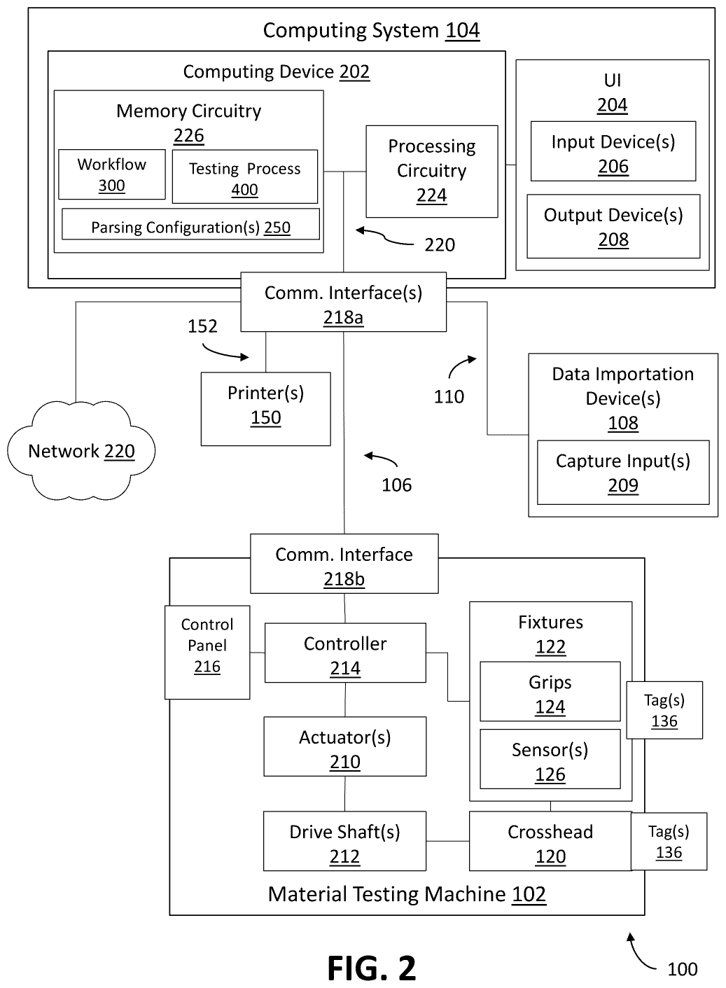

In the example of FIG. 1, the material testing machine 102 includes a frame 112. In some examples, the frame 112 provides rigid structural support for the other components of the material testing machine 102. As shown, the frame 112 comprises a top plate 114 and a bottom base 116 connected by two columns 118. In some examples, the columns 118 of the frame 112 may house guide rails and/or drive shafts 212 of the material testing machine 102 (see, e.g., FIG. 2).

In the example of FIG. 1, a movable crosshead 120 extends between the columns 118. In some examples, the movable crosshead 120 may be connected to the guide rails and/or drive shafts 212 housed in the columns 118, and/or configured to move toward and/or away from the base 116 through (e.g., motorized) actuation of the drive shaft(s) 212. While one movable crosshead 120 is shown in the example of FIG. 1, in some examples, the material testing machine 102 may have multiple movable crossheads 120, and/or other movable members.

In the example of FIG. 1, a fixture 122 is attached to the bottom base 116 of the frame 112, as well as to the movable crosshead 120. As shown, the lower fixture 122a includes a grip 124a, while the upper fixture 122b includes both a test sensor 126 and a grip 124b. While one test sensor 126 and two grips 124 are shown in the example of FIG. 1, in some examples, the testing machine 102 may include more or fewer test sensors 126 and/or grips 124.

In the example of FIG. 1, the grips 124 are holding a test specimen 128. While shown as a (e.g., steel) rope, in some examples, the test specimen 128 may be some other type of material and/or component. While shown as being dog bone grips, in some examples, the grip 124a and/or grip 124b may alternatively, or additionally, be configured as a bolt holder, wedge grip, side acting grip, manual grip, roller grip, capstan grip, and/or syringe holder. In some examples, one or both of the grips 124 may be replaced by a compression platen configured to compress the test specimen 128.

In the example of FIG. 1, the test sensor 126 is connected to the grip 124, such that the test sensor 126 can measure forces acting on the grip 124 (and/or specimen 128, crosshead 120, etc.). In some examples, the test sensor 126 may be a load cell. In some examples, the test sensor 126 may be some other type of sensor.

In some examples, the material testing machine 102 may be configured for static mechanical testing. For example, the material testing machine 102 may be configured for compression strength testing, tension strength testing, shear strength testing, bend strength testing, deflection strength testing, tearing strength testing, peel strength testing (e.g., strength of an adhesive bond), torsional strength testing, and/or any other compressive and/or tensile testing. Additionally or alternatively, the material testing machine 102 may be configured to perform dynamic testing.

In some examples, the material testing machine 102 is configured to interface with the computing system 104 to conduct a test method. In some examples, the computing system 104 may use data imported from the data importation device(s) 108 to conduct the test method, and/or analyze results of the test method. FIG. 1 shows several examples of data importation devices 108 that might be used to import data used to conduct the test method.

In the example of FIG. 1, each data importation device 108 is a device configured to send (and/or import) data to the computing system 104. For example, the data importation device 108 may be a digital caliper 130 (e.g., configured to measure one or more dimensions of a specimen 128, or of a component of the material testing machine 102, etc.). In some examples, a digital caliper 130 may include a multiplexer that combines and/or concatenates several measurements before importing. As another example, the data importation device 108 may be a camera 132. In some examples, the data importation device 108 may be a tag reader 134 configured to read data off a tag 136.

In some examples, a tag 136 may be attached to the specimen 128, a packaging of the specimen 128, a crosshead 120, a fixture 122 (see, e.g., FIG. 2), and/or some other component of the material testing machine 102. In some examples, the tag 136 may store information relating to the item to which the tag 136 is attached. In some examples, the tag 136 may be detached, and/or store information other than information relating to the item to which the tag 136 is attached.

In some examples, the tag 136 may be a one dimensional barcode tag 136a, a two dimensional barcode tag 136b (e.g., Quick Response code tag), a Bluetooth tag 136c (e.g., a tag 136 configured to use short-range ultra-high radio frequency in the 2.4 GHz Industrial, Scientific, and Medical (ISM) frequency band, between 2.402 and 2.480 GHz), a near field communication (NFC) tag 136d, a radio frequency identification (RFID) tag 136e, and/or some other type of tag 136. In some examples, the camera 132 may be configured to read and/or scan a one dimensional barcode tag 136a and/or two dimensional barcode tag 136b. In some examples, the camera 132 may be incorporated into the tag reader 134.

In some examples, the data importation device 108 may capture data in response to user activation of a trigger, button, or other capture input 209 of the data importation device 108 (see, e.g., FIG. 2). In some examples, (e.g., after capture) the data may also be sent (and/or imported) to the computing system 104 in response to user activation of the capture input 209 of the data importation device 108. In examples where the captured data is encoded (e.g., in a tag 136), the data importation device 108 may decode the encoded data before sending to the computing system 104, or the computing system 104 may decoded the encoded data after receiving the encoded data.

In the example of FIG. 1, the material testing system 100 further includes a tag printer 150. In some examples, the tag printer 150 is configured to print one or more tags 136 (e.g., one dimensional barcode tag 136a, two dimensional barcode tag 136b, etc.). In some examples, the computing system 104 provides data for the tag printer 150 to print the one or more tags 136. In some examples, the computing system 104 and/or tag printer 150 may encode the data prior to printing.

FIG. 2 is a block diagram of the material testing system 100. Similar to FIG. 1, the example of FIG. 2 shows the computing system 104 connected to the material testing machine 102 through cable 106. FIG. 2 further shows the data importation device 108 connected to the computing system 104 through cord 108, and the tag printer 150 connected to the computing system 104 through line 152. FIG. 2 also shows additional details of the material testing machine 102 and computing system 104.

In the example of FIG. 2, the computing system 104 includes a computing device 202 and a user interface (UI) 204 interconnected with one another. As shown, the UI 204 includes one or more input devices 206 configured to receive inputs from a user, and one or more output devices 208 configured to provide outputs to the user. In some examples, the one or more input devices 206 may comprise one or more touch screens, mice, keyboards, buttons, switches, slides, knobs, microphones, dials, and/or other input devices 206. In some examples, the one or more output devices 208 may comprise one or more display/touch screens, speakers, lights, haptic devices, and/or other output devices 208. The output device(s) 208 (e.g., a display screen) of the UI 204 may output one or more representations of a material testing workflow 300 configured to guide a user through setup, execution, and/or analysis of a test method conducted by the material testing machine 102.

In the example of FIG. 2, the example material testing machine 102 includes one or more actuators 210 connected with one or more drive shafts 212. In some examples, the actuators 210 may be used to provide force to, and/or induce motion of, the drive shafts 212. In some examples, the actuators 210 may include electric motors, pneumatic actuators, hydraulic actuators, piezoelectric actuators, relays, and/or switches.

The drive shafts 212 are further shown connected to the movable crosshead 120, such that movement of the drive shaft(s) 212 via the actuator(s) 210 will result in movement of the movable crosshead 120. While termed drive shafts 212 in the example of FIG. 2, in some examples, the drive shafts 212 may be some other mechanical means of moving the movable crosshead 120 though inducement by the actuator(s) 210.

The example material testing machine 102 is further shown as including a controller 214 in electrical communication with the actuator(s) 210. In some examples, the controller 214 may include processing circuitry and/or memory circuitry. In some examples, the controller 214 may be configured to control the material testing machine 102 based on one or more commands, control inputs, and/or test parameters. In some examples, the controller 214 may be configured to translate commands, control inputs, and/or test parameters (e.g., received from the computing system 104) to appropriate (e.g., electrical) signals that may be delivered to the actuator(s) 210, thereby controlling operation of the material testing machine 102 (e.g., via the actuator(s) 210). For example, the controller 214 may provide one or more signals(s) commanding more or less electrical power be provided to the actuator(s) 210, to thereby increase or decrease applied force.

In the example of FIG. 2, the controller 214 is further in electrical communication with the fixtures 122 (e.g., the grips 124 and test sensor(s) 126). In some examples, the controller 214 may be configured to translate commands, control inputs, and/or test parameters (e.g., received from the computing system 104) to appropriate (e.g., electrical) signals that may be delivered to the grips 124, to thereby control (e.g., grip or release) operation of the grips 124. In some examples, the controller 214 may be configured to translate commands, control inputs, and/or test parameters (e.g., received from the computing system 104) to appropriate (e.g., electrical) signals that may be delivered to the sensor(s) 126, to thereby control operation of the sensor(s) 126. In some examples, the controller 214 may be configured to translate measurement data received from the sensor(s) 126, and/or send measurement data to the computing system 104.

The example controller 214 is further shown as being in electrical communication with a control panel 216 of the material testing machine 102. In some examples, the control panel 216 may include one or more input devices (e.g., buttons, switches, slides, knobs, microphones, dials, and/or other electromechanical input devices). In some examples, the control panel 216 may be used by an operator to directly control the material testing machine 102. In some examples, the controller 214 may be configured to translate commands, control inputs, and/or test parameters received via the control panel 216 to appropriate (e.g., electrical) signals that may be delivered to the actuator(s) 210 and/or grip(s) 124 to control the material testing machine 102.

The controller 214 is also shown in electrical communication with a communication interface 218b of the material testing machine 102. In some examples, the communication interface 218b includes hardware, firmware, circuitry, and/or software to connect the material testing machine to the computing device 104 (e.g., wirelessly and/or through cable 106). In some examples, the controller 214 may receive information (e.g., commands) from the computing device 202 through the communication interface 218b, and/or send information (e.g., measurement data from sensor(s) 126) to the computing device 202 through the communication interface 218b.

The example computing device 202 includes one or more communication interfaces 218a. In some examples, the communication interfaces 218a may be network interfaces and/or input/output (I/O) interfaces. For example, the one or more I/O interfaces 222 may comprise one or more universal serial bus (USB) ports, Thunderbolt ports, FireWire (IEEE 1394) ports, and/or any other type of serial and/or parallel data port. In some examples, the communication interfaces include hardware, firmware, circuitry, and/or software to enable communication with external devices.

In the example of FIG. 2, one communication interface 218a is in communication with the communication interface 218b of the material testing machine 102 through cable 106. As shown, the computing device 102 is further in communication with a network 220 (e.g., the Internet), the tag printer 150, and the data importation device(s) 108 through the communication interface(s) 218a. In some examples, the computing device 202 may be in communication with other computing systems 104 and/or material testing machines 102 through the communication interface(s) 218a. As shown, the communication interface 218b is electrically connected to a common electrical bus 220 of the computing device 202.

The computing device 202 further includes processing circuitry 224 connected to the common electrical bus 220. In some examples, the processing circuitry 224 may comprise one or more processors. In some examples, the processing circuitry 224 is configured to process information received from the UI 204, data importation device(s) 108, and/or material testing machine 102. In some examples, the processing circuitry 224 is configured to transmit (e.g., via communication interface(s) 218a) commands and/or test parameters to the material testing machine 102. In some examples, the processing circuitry 224 is configured to output information to an operator through the UI 204. In some examples, the computing device 202 is configured to execute machine readable instructions stored in memory circuitry 226.

The example computing device 202 further includes memory circuitry 226 connected to the common electrical bus 220. As shown, the memory circuitry 226 includes (and/or stores) a material testing workflow 300, a testing process 400, and one or more parsing configurations 250. While shown as part of the memory circuitry 226 in the example of FIG. 2, in some examples, the material testing workflow 300, testing process 400, and/or parsing configuration(s) 250 may be implemented using discrete circuitry (e.g., of the processing circuitry 224).

In some examples, the material testing workflow 300, testing process 400, and/or parsing configuration(s) 250 are implemented using non-transitory machine readable instructions stored in the memory circuitry 226. In some examples, the processing circuitry 224 is configured to execute the machine readable instructions of the material testing workflow 300 to guide a user through setup, execution, and analysis of a test method of the material testing machine 102. In some examples, the computing device 202 is configured to interface with the controller 214 of the material testing machine 102 to execute the test method during the material testing workflow 300.

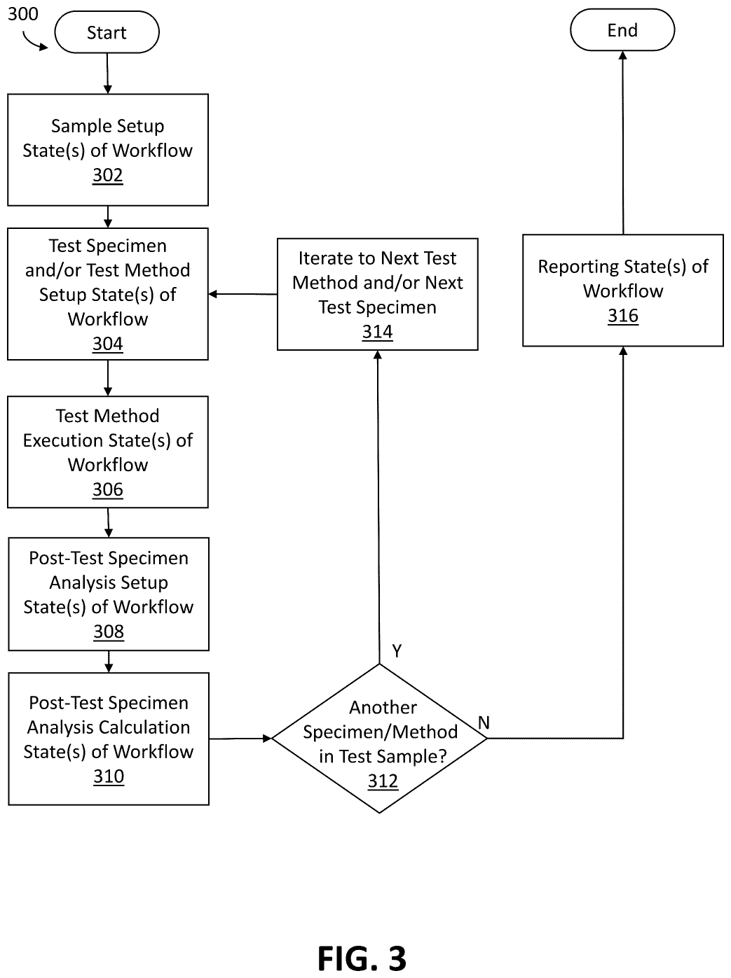

FIG. 3 is a flowchart showing example workflow states of the material testing workflow 300. While a specific order of workflow states are shown, in some examples, the material testing workflow 300 may be customizable such that additional and/or fewer workflow states may be implemented in operation. Additionally, numerous alternative progressions through a workflow 300 may be possible.

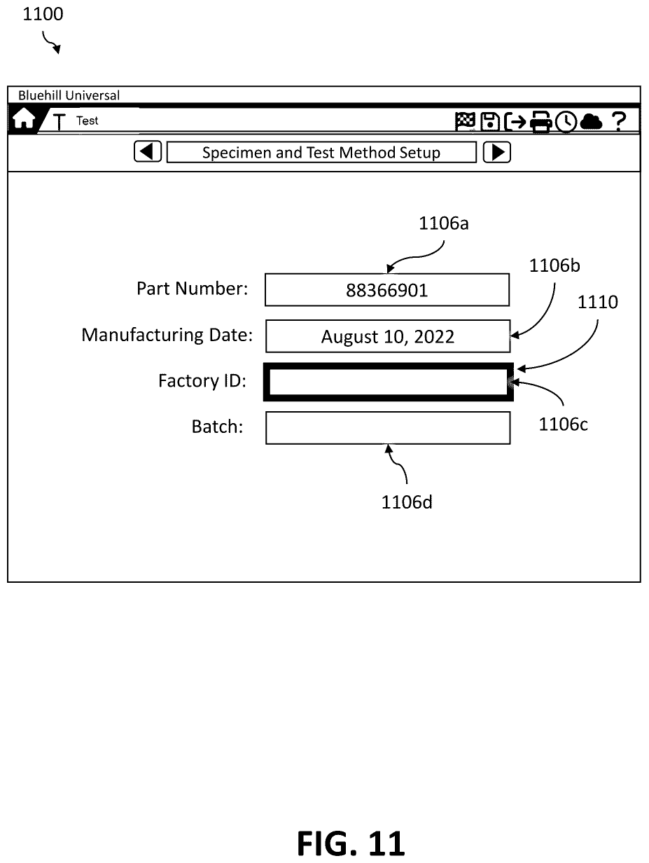

In some examples, the material testing workflow 300 progresses through the workflow states to guide a user through setup, execution, and analysis of a test method of the material testing machine. In some examples, a particular workflow state may be associated with an output of the UI 204 (e.g., a display state of a workflow GUI 1100; see FIG. 11). While the material testing workflow 300 is sometimes described below as conducting certain actions for the sake of understanding, it should be understood that one or more of the above described components of the material testing system 100 (e.g., the processing circuitry 224, UI 204, etc.) may undertake the actions on behalf (and/or according to instructions) of the material testing workflow 300.

In the example of FIG. 3, the first workflow state is a sample setup state 302 (and/or a plurality of sample setup states 302). During the example sample setup state(s) 302, the material testing workflow 300 prompts an operator for information pertaining to a set of specimens 128 of a sample, as well as information pertaining a set of test methods that will be used to test the specimens 128 of the sample.

The information prompted for (and/or collected) during the sample setup state(s) 302 may be information that is applicable to all the specimens 128 and test methods of the sample, such as, for example, a date the test(s) will be run, a date the specimens 128 were manufactured/shipped/packaged, identification information (e.g., number, name, etc.) of the operator, identification information (e.g., number(s), name(s), etc.) of the fixture(s), and/or other information relevant to all the tests of all the specimens 128. In some examples, data prompted for (and/or collected) during the sample setup state(s) 302 may be imported, such as, for example, by reading a tag 136 attached to (and/or capturing an image of) a packaged sample of specimens 128, a material testing machine 102, and/or component of the material testing machine 102 (e.g., fixture 122, crosshead 120, etc.). As another example, the computing device 202 may load from memory circuitry 226, or download through the network 220, information based on an image captured by the data importation device(s) 108 (e.g., an image of a packaged sample of specimens 128, material testing machine 102, and/or component of the material testing machine 102).

In the example of FIG. 3, the sample setup state 302 is followed by one or more test specimen and/or test method setup states 304. During the test specimen and/or test method setup state(s) 304, the material testing workflow 300 prompts an operator for (and/or collects) information pertaining to a particular specimen 128 of a sample, and/or information pertaining a particular test method that will be used to test the particular specimen 128. For example, the information prompted for (and/or collected) during the test specimen and/or test method setup state(s) 304 may include a date the test will be run, a date the specimen 128 was manufactured/shipped/packaged, identification information of the specimen 128 (e.g., number, name, description, etc.), identification information of the test (e.g., number, name, description, etc.), pre-test characteristics of the specimen 128 (e.g., measurements, material type, weight, color, shape, etc.), target parameters of the test (e.g., start/end positions of grip(s) 124/crosshead 120, distance moved by crosshead 120, speed of movement of crosshead 120, expected result(s) of test (e.g., position/type of break, distance moved before break, force applied before break, post-test characteristics of sample, etc.), time(s) when sensor(s) 126 should take measurement(s), etc.), and/or other information relevant to a particular test method and/or a particular specimen.

In some examples, information prompted for (and/or collected) during the test specimen and/or test method setup state(s) 304 may be imported. For example, the data importation device(s) 108 may import information read from a tag 136 attached to a specimen 128 (and/or associated packaging), material testing machine 102, and/or component of the material testing machine 102 (e.g., fixture 122, crosshead 120, etc.). As another example, the data importation device(s) 108 may import information regarding the specimen 128 measured by a digital caliper 130. As another example, the computing device 202 may load from memory circuitry 226, or download through the network 220, information relating to the specimen 128 based on an image captured by the data importation device(s) 108.

In the example of FIG. 3, the test specimen and/or test method setup state 304 is followed by a test method execution state 306 (and/or test method execution states 306). During the test method execution state(s) 306, the computing device 202 communicates with the material testing machine 102 (e.g., via communication interfaces 218) to execute the test method on the test specimen 128 using the material testing machine 102 according to the information received during the test specimen and/or test method setup state(s) 304 and/or sample setup state(s) 302. For example, the processing circuitry 224 of the computing device 202 may determine and/or send one or more parameters and/or commands to the material testing machine 102, and the controller 214 of the material testing machine 102 may control the actuator(s) 210 of the material testing machine 102 to execute the test method in accordance with the command(s) and/or parameter(s).

In the example of FIG. 3, the test method execution state 306 is followed by one or more post-test analysis setup states 308. During the post-test analysis setup state(s) 308, the material testing workflow 300 prompts an operator for (and/or collects) information pertaining to an analysis of the test method that was executed during the test method execution state 306.

For example, the information prompted for (and/or collected) during the post-test specimen analysis setup state(s) 308 may include post-test characteristics of the specimen 128, actual parameters of the test, actual results of the test, and/or other information relevant to an analysis of the test method and/or test sample. While shown as a separate state in FIG. 3, in some examples, the post-test specimen analysis setup state(s) 308 may be integrated into the test specimen and/or test method setup state(s) 304.

In the example of FIG. 3, the one or more post-test specimen analysis setup states 308 are followed by one or more post-test specimen analysis calculation states 310 of the material testing workflow 300. During the post-test specimen analysis calculation state(s) 310, the processing circuitry 224 of the computing device 202 may perform one or more calculations based on the information collected during the previous post-test specimen analysis setup state(s) 308. For example, the processing circuitry 224 may estimate a strength, reliability, quality, grade, resiliency, and/or other characteristic of the specimen 128. As another example, the processing circuitry 224 may hypothesize about the structure and/or composition of the specimen 128. As another example, the processing circuitry may hypothesize about the future performance of the specimen 128.

In the example of FIG. 3, the material testing workflow 300 repeats states 304-310 for all the test methods and/or test specimens of the test sample (setup at state 302). As shown, after state 310, the material testing workflow 300 iterates to the next test method and/or test specimen at state 314 (provided there is another test method or test specimen), then returns to state 304. Once states 304-310 have been completed for all the test methods and/or test specimens of the test sample, the material testing workflow 300 moves through one or more reporting state(s) 316, where the material testing workflow 300 may provide reports on the results of the test sample according to operator specifications. After the reporting state(s) of the material testing workflow 300, the material testing workflow 300 ends.

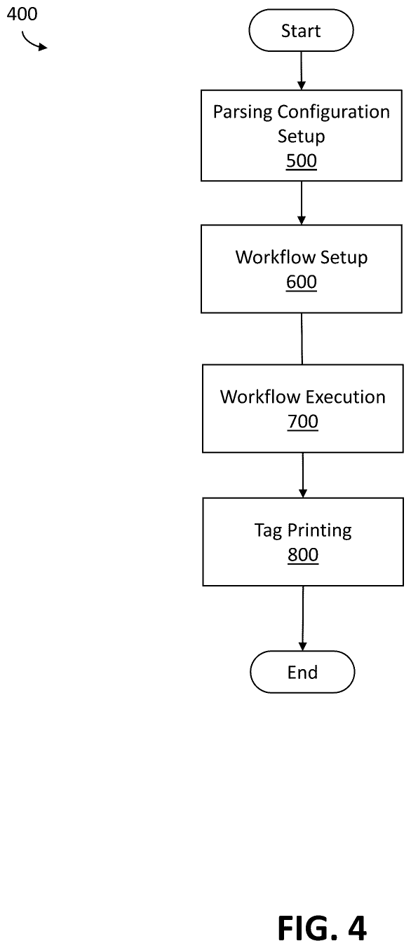

FIG. 4 is a flowchart depicting an example operation of a testing process 400 that may handle setup and/or execution of the workflow 300. In some examples, the testing process 400 may additionally handle setup of one or more parsing configuration(s) 250 that might be used during execution of the workflow 300 to separate a piece of imported data into several smaller data portions. The testing process 400 may additionally handle execution of a tag printing process 800 that combines several smaller data portions into one larger piece of data using an inversion of the parsing configuration(s) 250, and then prints a tag 136 encoded with the larger piece of data. While the testing process 400 is sometimes described below as conducting certain actions for the sake of understanding, it should be understood that one or more of the above described components of the material testing system 100 (e.g., the processing circuitry 224, UI 204, etc.) may undertake the actions on behalf (and/or according to instructions) of the testing process 400.

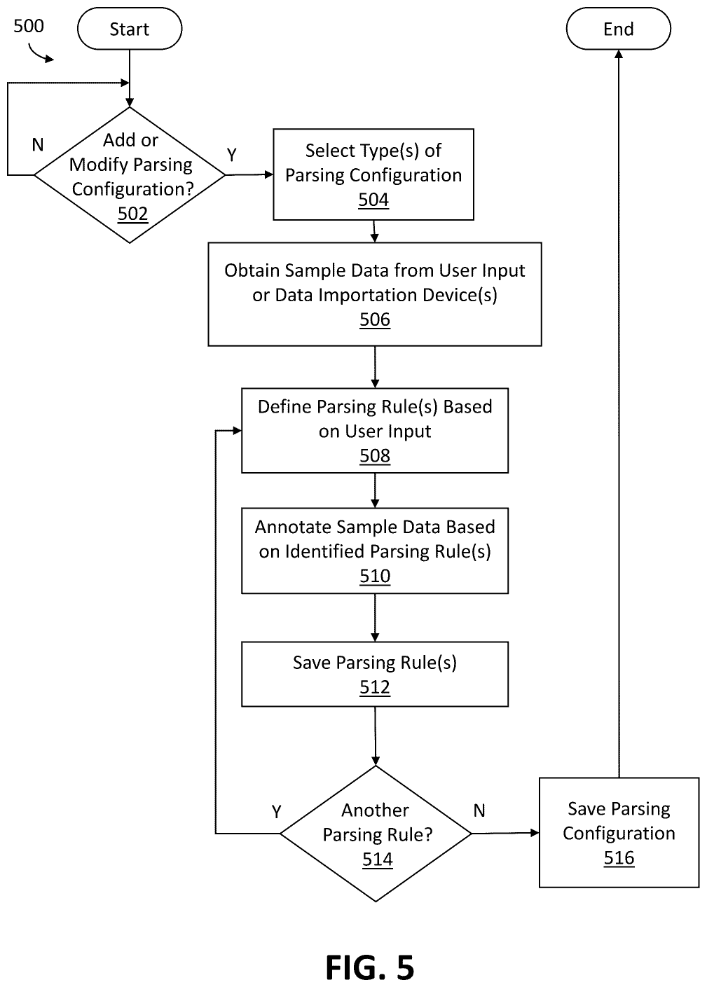

In the example of FIG. 4, the testing process 400 begins with a parsing configuration setup process 500. In some examples, the one or more parsing configurations 250 are created and/or modified during the parsing configuration setup process 500. The parsing configuration setup process 500 is discussed further below with respect to FIG. 5.

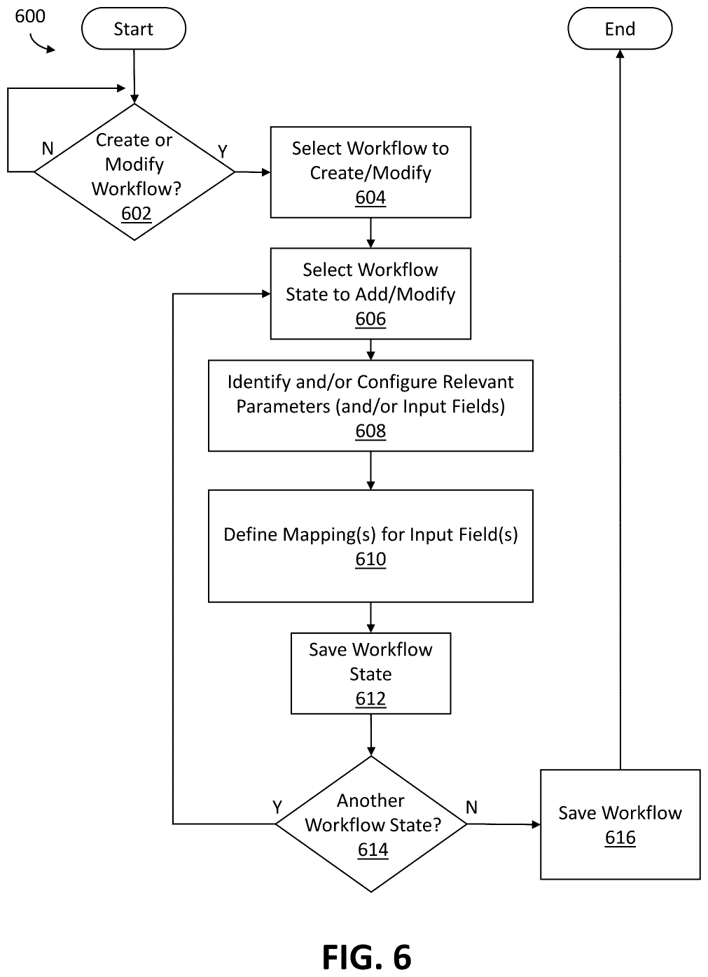

In the example of FIG. 4, after the parsing configuration setup process 500, the testing process 400 proceeds to a workflow setup process 600. In some examples, one or workflows 300 may be created and/or modified during the workflow setup process 600. The workflow setup process 600 is discussed further below with respect to FIG. 6.

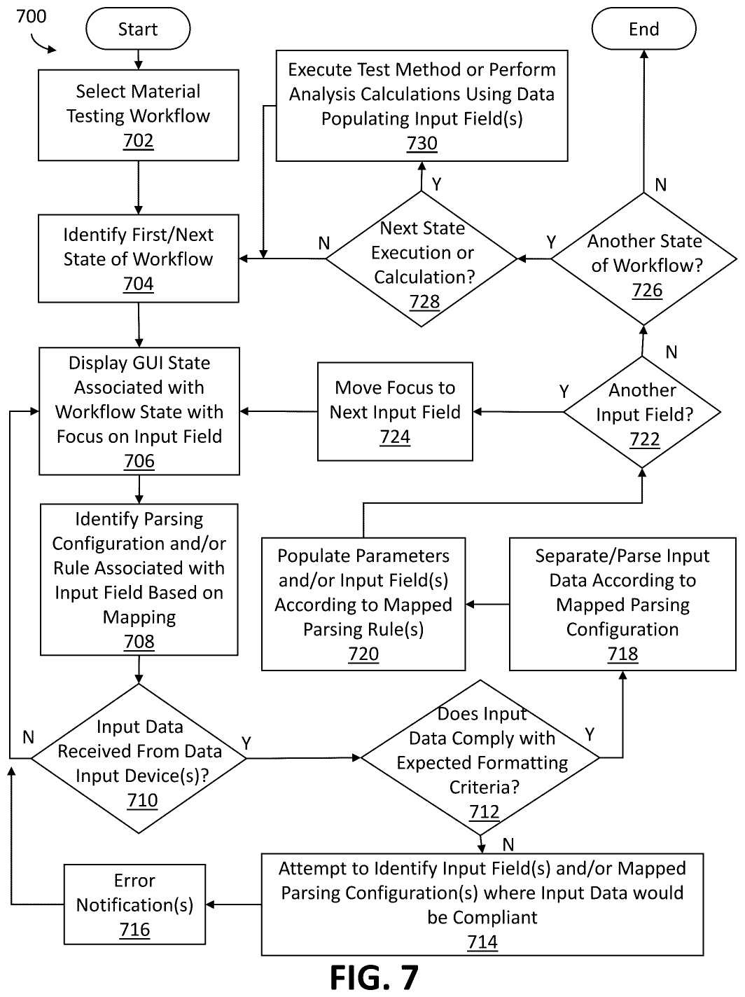

In the example of FIG. 4, after the workflow setup process 600, the testing process 400 proceeds to a workflow execution process 700. In some examples, one or more workflows 300 (e.g., created and/or modified during the workflow setup process 600) are executed during the workflow execution process 700. In some examples, one or more of the parsing configurations 250 (e.g., created and/or modified during the parsing configuration setup process 500) may be used during the workflow execution process 700. The workflow execution process 700 is discussed further below with respect to FIG. 7.

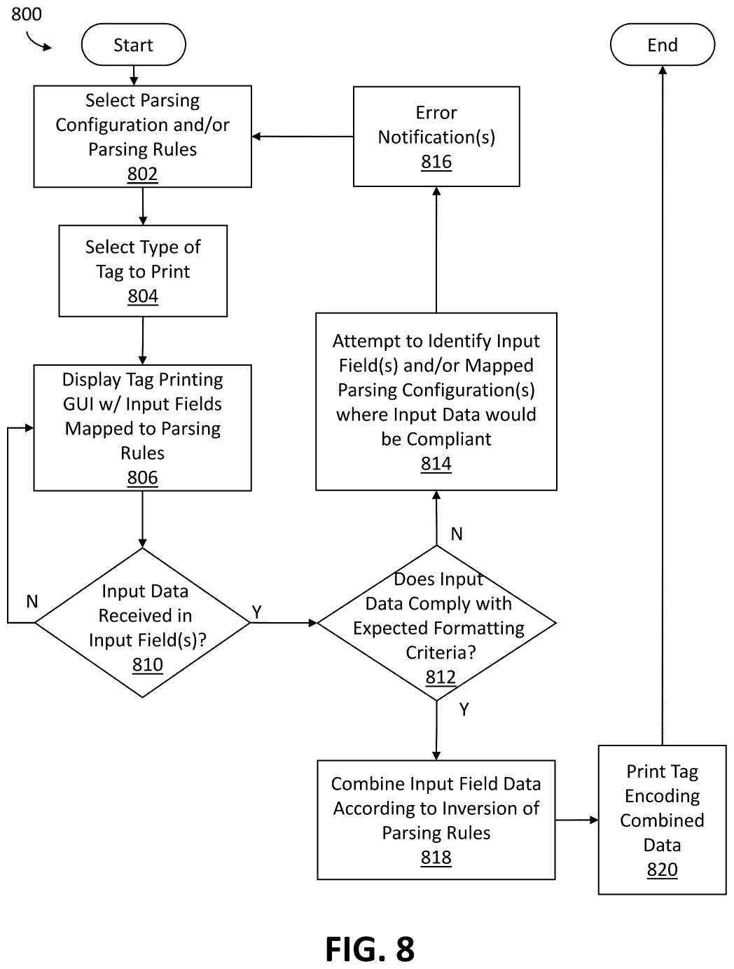

In the example of FIG. 4, after the workflow execution process 700, the testing process 400 proceeds to a tag printing process 800. In some examples, the tag printing process 800 uses an inversion of a parsing configuration 250 (e.g., created and/or modified during the parsing configuration setup process 500) to combine several smaller portions of data into one larger piece of data, and then print a tag 136 encoding the larger piece of combined data. While shown in the example of FIG. 4, as occurring at the end of the testing process 400, in some examples, the tag printing process 800 may occur at other times during the testing process 400. The tag printing process 800 is discussed further below with respect to FIG. 8.

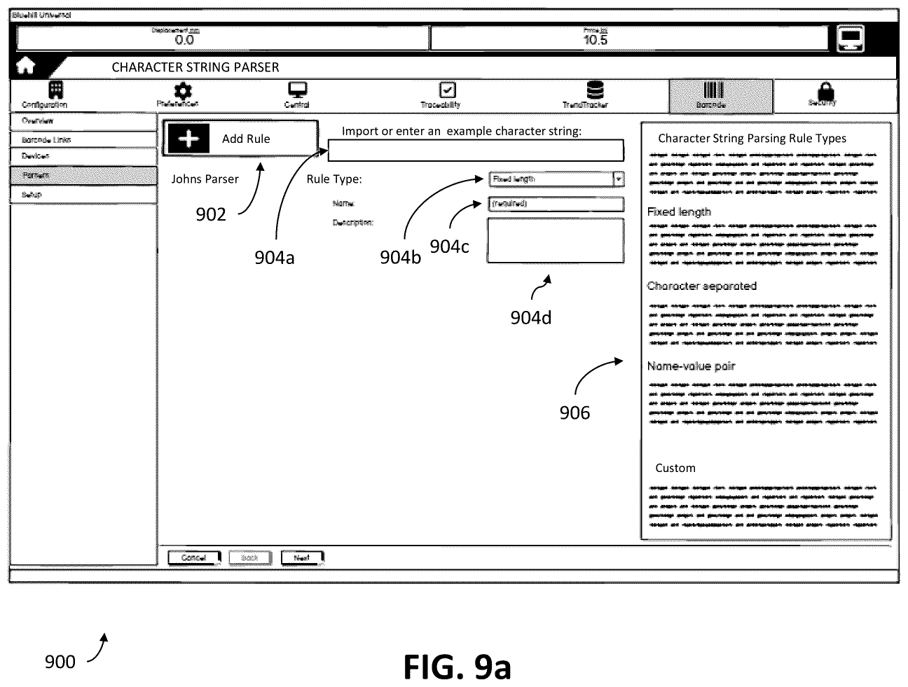

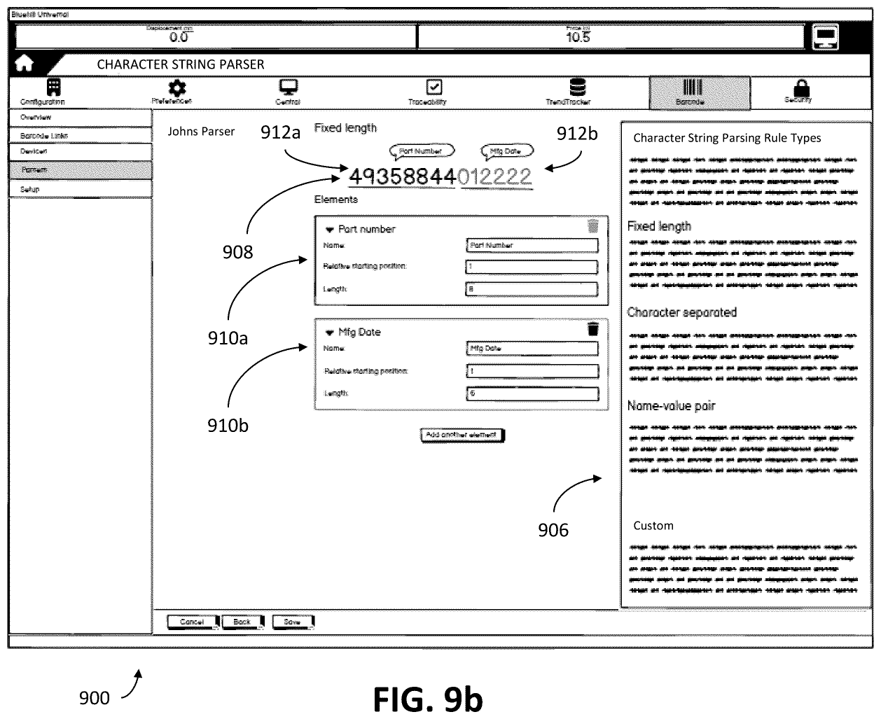

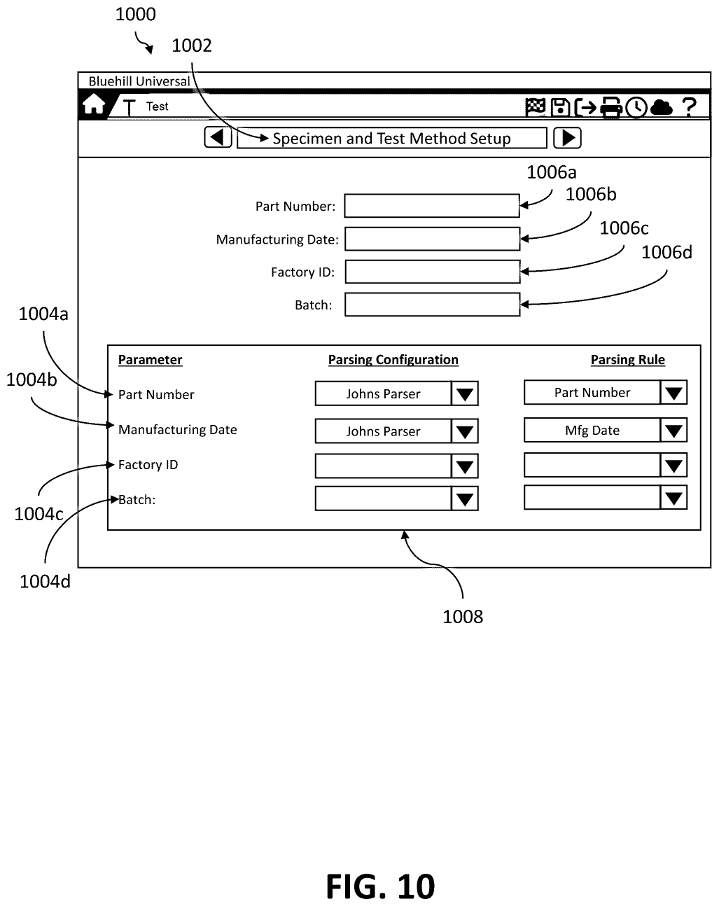

FIG. 5 is a flowchart showing an example operation of the parsing configuration setup process 500 (i.e., the first block in the testing process 400 shown in FIG. 4). In some examples, the parsing configuration setup process 500 provides a parsing setup GUI 900 through which a user can create and/or modify one or more parsing configurations 250 (see, e.g., FIGS. 9a-9b). More particularly, during the parsing configuration setup process 500, a user may define one or more parsing rules 910 according to which imported data may be separated (and/or parsed) into smaller portions of data (see, e.g., FIG. 10). While the parsing configuration setup process 500 is sometimes described below as conducting certain actions, it should be understood that one or more of the above described components of the material testing system 100 (e.g., the processing circuitry 224, UI 204, etc.) may undertake the actions on behalf (and/or according to instructions) of the parsing configuration setup process 500.

In the example of FIG. 5, the parsing configuration setup process 500 begins at block 502, where the parsing configuration setup process 500 loops until an input is received (e.g., via the UI 204) indicating that a user wants to add or modify a parsing configuration 250. If no such input is received, the parsing configuration setup process 500 repeats block 502. Once an input is received, the parsing configuration setup process 500 proceeds to block 504.

At block 504, the parsing configuration setup process 500 selects one or more types of parsing configurations 250 to add or modify. When modifying an existing parsing configuration 250, the parsing configuration setup process 500 selects a type previously associated with the saved parsing configuration 250. When adding a new parsing configuration 250, the parsing configuration setup process 500 may select a type for the new parsing configuration 250 based on input from a user (e.g., received via UI 204).

In some examples, the parsing configuration setup process 500 may present a parsing setup GUI 900 that allows for selection of a parsing configuration 250 at block 504. In some examples, the parsing configuration setup process 500 may present (e.g., via parsing setup GUI 900) several parsing configurations 250 for a user to choose from amongst at block 504. In some examples, a type of parsing configurations 250 may be associated with a type of data (and/or type(s) of data importation device(s) 108) the parsing configuration 250 is designed to handle. In some examples, a particular type of parsing configuration 250 may further be associated with particular kinds of parsing rules 910 that the parsing configuration 250 can accommodate.

For example, one type of parsing configuration 250 might be an image based parsing configuration 250 (e.g., designed for parsing image data). In such an example, each parsing rule 910 of the parsing configuration 250 might be defined with respect to an image to be parsed. Another example of a type of parsing configuration 250 might be a numerical parsing configuration 250 (e.g., designed for parsing numerical data). In such an example, each parsing rule 910 of the parsing configuration 250 might be defined with respect to numerical data expected to be parsed. Another example of a type of parsing configuration 250 might be a character string parsing configuration 250 (e.g., designed for parsing character strings). In such an example, each parsing rule 910 of the parsing configuration 250 might be defined with respect to a character string to be parsed.

Once a type of parsing configuration 250 is selected at block 504, the parsing configuration setup process 500 proceeds to block 506 where sample data may be input by the user and subsequently displayed (e.g., via parsing setup GUI 900). In some examples, the sample data may be manually input by the user (e.g., via UI 204) or automatically imported (e.g., via the data importation device(s) 108). While having sample data may make setup of the parsing rules easier, such as by providing a visualization that the user can interact with to define the parsing rule(s) 910, in some examples, block 506 may be skipped.

FIG. 9a shows an example of a parsing setup GUI 900 where the user has selected a character string parsing configuration 250 (e.g., at block 504), and is about to enter sample data. The parsing setup GUI 900 is shown as providing a selectable “add rule” input 902 that would allow a user to add a new parsing rule 910. The parsing setup GUI 900 additionally has a sample data input field 904a into which a user may input the sample data (e.g., via UI 204), and/or into which sample data may be imported (e.g., via selection of a capture input 209 of the data importation device(s) 108). The parsing setup GUI 900 also has input fields 904b-904d which allow a user to select a type of parsing rule, a name for the parsing rule, and/or a description of the parsing rule.

After a type of parsing configuration 250 is selected at block 504, and sample data (potentially) entered/imported at block 506, the parsing configuration setup process 500 proceeds to block 508 where one or more parsing rules 910 may be defined. In some examples, the one or more parsing rules may be defined based on user interaction with the parsing setup GUI 900 (e.g., via the UI 204). For example, the user interaction may be interaction with one or more selectable inputs 902 and/or input fields 904 of the parsing setup GUI 900. As another example, the user interaction may be with the sample data input into, and/or displayed by, the parsing setup GUI 900.

In some examples, each parsing rule 910 may identify a rule according to which a piece of (e.g., imported) data may be parsed (and/or separated) into two or more smaller portions of data. For example, a parsing rule 910 might indicate that the first four characters of an imported character string should be separated (and/or parsed) from the rest of the imported character string into its own sub-string. Another example of a parsing rule 910 might be that all characters of an imported character string that occur after a “z” and/or before a semicolon (;) should be parsed into a separate sub-string. Another example of a parsing rule 910 might be that an image should be separated into x many equal parts, where x is a number defined in the metadata of an imported image file (e.g., at the 5^{th} and 6^{th} characters of the metadata, or after a “size:” character string). Another example parsing rule 910 might indicate that a certain number of significant digits after a decimal point should be separated from the rest of imported numerical data, or that the characters occurring after the numbers in an alphanumeric string should be separated from the rest of the string (e.g., because those characters specify the units).

The parsing setup GUI shown in FIGS. 9a-9b includes parsing rule guidance 906 presented in a side ribbon. As shown, the rule guidance 906 describes four different types of character string parsing rules: fixed length, character separated, name-value pairs, and custom. In some examples, a fixed length character parsing rule 910 may define a sub-string according to a number of characters in the sub-string, as well as a starting and/or ending position. In some examples, a character separated parsing rule 910 may define a sub-string according to a starting and/or ending position, where the starting and/or ending position is identified by a particular character that occurs at the start and/or end of the sub-string (and/or directly before/after the start/end of a sub-string). In some examples, a name-value pair parsing rule 910 may define a sub-string according to a starting and/or ending position, where the starting and/or ending position is identified by one or more particular words (or character strings) that occur at the start and/or end of the sub-string (and/or directly before/after the start/end of a sub-string), where the particular word(s) may also be used to identify the information in the sub-string (e.g., ID12345; where ID is the particular word, and 12345 is the ID information). In some examples, a custom character parsing rule 910 may define a sub-string according to some customized parameters, such as, for example, an amalgamation of one or more of the other rules (e.g., a character string that begins at the 5^{th} character and ends directly prior to “ID”).

In some examples, the smaller data portions separated/parsed according to parsing rules 910 may be non-overlapping, such that each smaller data portion contains no data from any other smaller data portion. However, in some examples, one or more smaller data portions may contain data shared by one or more other smaller data portions.

In the example of FIG. 5, following the definition of one or more parsing rules 910 at block 508, the parsing configuration setup process 500 annotates the provided sample data at block 510. In some examples, the annotation(s) 912 may indicate which portion of the sample data (provided at block 506) would be parsed according to the recently defined parsing rule 910. In some examples, the annotation 912 may additionally indicate (e.g., using name, description, etc.) the particular parsing rule 910 according to which the annotated portion would be parsed.

FIG. 9b shows an example of the parsing setup GUI 900 after input/importation of sample data 908, definition of parsing rules 910, and annotation of the sample data 908 according to the parsing rules 910 (at blocks 506-510). Two parsing rules 910 and two annotations 912 are shown. Both parsing rules 910 are fixed length character string parsing rules 910. The first parsing rule 910a defines a first (part number) sub-string as starting at the first character of the sample data 908, and having a length of eight characters. The second parsing rule 910b defines a second (manufacturing date) sub-string as starting at the ninth character of the sample data 908, and having a length of six characters.

In the example of FIG. 9b, the annotation 912a indicates, via underlining and word bubble, that the first eight characters of the sample data 908 would be parsed out according to the first parsing rule 910. The annotation 912b identifies the next six characters of the sample data 908 as being parsed out according to the second parsing rule 910b. While a character string parsing configuration 250 with two character string specific parsing rules 910 and corresponding annotations 912 are shown in the example of FIG. 9b for the sake of simplicity, in some examples, there may be (and/or the parsing setup GUI 900 may show) different types of parsing configurations 250 with different and/or more parsing rules 910 and/or annotations 912.

In the example of FIG. 5, once the parsing rule(s) 910 are defined at block 510, the parsing configuration setup process 500 proceeds to block 512 where the parsing rule(s) 910 are saved in memory circuitry 226. Block 514 then determines whether there are more parsing rules 910 to be defined, such as, for example, by prompting a user and/or evaluating subsequent input. The parsing configuration setup process 500 loops through blocks 508-514 until all the parsing rules 910 have been defined and saved, then saves the overall parsing configuration 250 at block 516. While shown as ending after block 516, in some examples, the parsing configuration setup process 500 may instead return to block 502 after block 516.

FIG. 6 is a flowchart showing an example operation of the workflow setup process 600 (i.e., the second block in the testing process 400 shown in FIG. 4). In some examples, the workflow setup process 600 provides a workflow setup GUI 1000 through which a user can create and/or modify one or more workflows 300. More particularly, the workflow setup GUI 1000 may allow a user to configure one or more workflow states, as well as one or more mappings/associations between testing parameters 1004 of a workflow state and parsing rules 910 of a parsing configuration 250.

In the example of FIG. 6, the workflow setup process 600 begins at block 602, where the workflow setup process 600 loops until an input indicating that a user wants to add or modify a workflow 300 is received (e.g., via the UI 204). Once the input is received, the workflow setup process 600 proceeds to block 604, where the workflow setup process 600 selects a workflow 300 to create or modify (e.g., based on input received from the UI 204). Subsequently, the workflow setup process 600 proceeds to block 606 where (e.g., based on input from the UI 204) the workflow setup process 600 selects a state of the selected workflow 300 to add or modify (e.g., one of the workflow states shown in FIG. 3).

In the example of FIG. 6, after block 606, the workflow setup process 600 identifies one or more testing parameters 1004 (and/or input fields) that are relevant to the selected workflow state at block 608. In some examples, the workflow setup process 600 additionally configures one or more properties of the testing parameters 1004 (and/or input fields). For example, the workflow setup process 600 may configure the data type (and/or data size) of a parameter (e.g., boolean, number, character string, image, date, phone number, zip code, etc.). In some examples, the identification(s) and/or configuration(s) may be based on input received from a user (e.g., via the UI 204). In some examples, the identification(s) and/or configuration(s) may be based on one or more previously configured workflow states and/or parameters 1004.

After block 608, the workflow setup process 600 proceeds to block 610 where one or more mappings may be defined. In some examples, a mapping may associate (and/or map) a testing parameter 1004 (and/or associated input field) with a parsing rule 910 of a parsing configuration 250. Thereby, if and when imported data is received from the data importation device(s) 108 for the parameter 1004 (and/or input field), the system 100 can look to the mapping to determine which parsing configuration 250 (and/or parsing rule 910) to use to parse the imported data. The parsing rule 910 may additionally identify which particular portion of the imported data should be applied to the parameter 1004 (and/or input field). To the extent other portions of the imported data are mapped to other parameters 1004 (and/or input fields), the system 100 may additionally parse out those other portions (according to the other mapped parsing rule(s) 910) and populate those parameters 1004 (and/or input fields) as well. In some examples, the workflow setup process 600 may only allow mapping of a parameter 1004 (and/or input field) with a parsing rule 910 where both are configured for the same type of data (e.g., numerical data, character strings, dates, images, etc.). In some examples, the mapping(s) may be defined based on user input (e.g., received via UI 204).

After the mappings for the identified parameters 1004 of the selected workflow state are defined at block 610, the workflow setup process 600 proceeds to block 612 where the workflow state (and/or associated parameters 1004 and/or mappings) are saved to memory circuitry 226. As shown, the workflow setup process 600 then repeats blocks 606-612 until the user indicates (e.g., via UI 204) that they are finished creating or modifying states for the selected material testing workflow 300. Once finished creating/modifying states for the selected material testing workflow 300, all the information for the material testing workflow 300 is saved to memory circuitry 226 at block 616. While the workflow setup process 600 is shown ending after block 616 in the example of FIG. 6, in some examples, the workflow setup process 600 may instead return to block 602.

FIG. 10 shows an example of a workflow setup GUI 1000 that enables a user to create mappings that associate parsing rules 910 with parameters 1004 (and/or input fields 1006) of a workflow state. In the example of FIG. 10, the workflow setup GUI 1000 is shown as having a state identifier 1002 that identifies the state of the material testing workflow 300 being configured by the workflow setup GUI 1000. The workflow setup GUI 1000 also shows four testing parameters 1004 (corresponding to four input fields 1006) associated with the workflow state identified by the state identifier 1002.

In the example of FIG. 10, the workflow setup GUI 100 has a mapping window 1008 that identifies mappings (and/or associations) between the parameters 1004 (and/or input fields 1006) of the workflow state and the parsing rules 910 of a selected parsing configuration 250. As shown, the mapping window 1008 indicates that two parameters 1004 (and/or input fields 1006) have been mapped to two parsing rules 910 of two parsing configurations 250. While each of the two parameters 1004 (and/or input fields 1006) has been mapped to the same parsing configuration 250 in the example of FIG. 10, in some examples, different parameters 1004 (and/or input fields 1006) may be mapped to different parsing configurations 250. The mapping window 1008 further shows that two other parameters 1004 (and/or input fields 1006) remain unmapped. In some examples, the remaining parameters 1004 (and/or input fields 1006) may be mapped using other parsing configurations 250, or may be populated by manual input.

FIG. 7 is a flowchart showing an example operation of the workflow execution process 700 (i.e., the third block in the testing process 400 shown in FIG. 400). While the workflow execution process 700 is sometimes described below as conducting certain actions for the sake of understanding, it should be understood that one or more of the above described components of the material testing system 100 (e.g., the processing circuitry 224, UI 204, etc.) may undertake the actions on behalf (and/or according to instructions) of the workflow execution process 700.

In some examples, one or more workflows 300 (e.g., created and/or modified during the workflow setup process 600) are executed during the workflow execution process 700. In some examples, one or more of the parsing configurations 250 (e.g., created and/or modified during the parsing configuration setup process 500) may be used during the workflow execution process 700. Further, data portions parsed/separated from imported data according to one or more parsing rules 910 (of the parsing configuration(s) 250) may be used to populate parameters 1004 (and/or input fields 1006) of a workflow 300. The workflow execution process 700 may use the populated parameters 1004 to execute and/or evaluate a test method, according to the specifications set forth in the workflow 300.

In the example of FIG. 7, the workflow execution process 700 begins at block 702, where a material testing workflow 300 is selected and/or loaded (e.g., based on UI 204 input). Afterwards, at block 704, the workflow execution process 700 identifies the next state of the material testing workflow 300. In some examples (e.g., when first started), the next state may be the first state. Following block 706, the workflow execution process 700 outputs a workflow GUI 1100 (and/or other outputs) associated with the identified state of the material testing workflow 300 at block 706 (see, e.g., FIG. 11).

When the workflow GUI 1100 is output at block 706 (e.g., via UI 204), the workflow GUI 1100 may focus on a particular input field 1106 (e.g., the first input field 1106a) as a default. In some examples, the workflow GUI 1100 may focus on a different input field 1106 in response to user interaction (e.g., via the UI 204). In some examples, when a particular input field 1106 is focused upon, input data that is received (e.g., via the UI 204 and/or data importation device(s) 108) will be used to populate that particular input field 1106 (and/or to set a value of a parameter 1004 associated with the input field 1106).

In the example of FIG. 7, after block 706, the workflow execution process 700 proceeds to block 708, where the workflow execution process 700 identifies a parsing configuration 250 and/or parsing rule 910 associated with the focused upon input field 1106. When imported data is received from the data importation device(s) 108 at block 710, the workflow execution process 700 checks to ensure that the received imported data complies with one or more expected formatting criteria associated with the input field 1106, parsing configuration 250, and/or parsing rule 910. Expected formatting criteria may refer, for example, to an expected type of imported data (e.g., image, numerical, character string, etc.), an expected size of the imported data (e.g., number of bits/bytes, number of characters, number of pixels, etc.), a source of the imported data (e.g., tag reader 134, camera 132, etc.), and/or other criteria. In some examples, the criteria may be set and/or saved during the parsing configuration setup process 500 and/or workflow setup process 600.

In the example of FIG. 7, if the imported data does not comply with the expected formatting criteria at block 712, the workflow execution process 700 may attempt to identify expected formatting criteria for one or more input fields 1106 and/or mapped parsing configurations 250 to which the input data would comply at block 714. Afterwards, at block 716, the workflow execution process 700 outputs one or more error notifications (e.g., via UI 204). In some examples, an error notification may be a visual or audio message, alert, or alarm indicating that the imported data does not comply with an expected formatting criteria. In some examples, the notification(s) may identify the criteria met and/or unmet. In some examples, the notification(s) may indicate whether the input data would comply (or come closer to complying) with other input fields 1106 and/or mapped parsing configurations 250. Where the input data would comply (or come closer to complying) with other input fields 1106 and/or mapped parsing configurations 250, the workflow execution process 700 may provide the option of using the input data for those input field(s) 1106 and/or parsing configuration(s) 250 (e.g., by moving the field focus). After the notification(s) of block 716, the workflow execution process 700 returns to block 706.

If, on the other hand, the imported data does comply with the expected formatting criteria at block 712, the workflow execution process 700 proceeds to block 718, where the workflow execution process 700 separates the imported data into a plurality of smaller data portions according to the parsing rules 910 of the parsing configuration 250 identified at block 708. After the imported data is separated/parsed into the smaller data portions, the smaller data portions are used to populate the input field(s) 1106 (and/or set the parameter(s) 1004) of the workflow 300 at block 720 according to the mapped parsing rules 910. To the extent one or more parsing rules 910 of the parsing configuration 250 are mapped to input fields 1106 and/or parameters 1004 associated with other states of the workflow 300, those data portions may be stored until the workflow execution process 700 executes (and/or identifies) the appropriate workflow state (e.g., at block 704).

If the workflow execution process 700 determines (at block 722) that there is another unfilled input field 1106 (and/or unset parameter 1004) associated with the workflow GUI 1100 (and/or workflow state), the workflow execution process 700 moves the focus to the next unfilled input field 1106 (and/or parameter 1004) at block 724 then returns to block 706. If there are no more unfilled input fields 1106 (and/or parameters 1004), the workflow execution process 700 determines (at block 726) whether is another (as of yet unexecuted) state of the material testing workflow 300. If there is another (as of yet unexecuted) state of the material testing workflow 300, and the next state is not an execution or analysis calculation state, the workflow execution process 700 returns to block 704, where the next state is identified. If there is another (as of yet unexecuted) state of the material testing workflow 300, and the next state is an execution or analysis calculation state (as determined at block 728), the workflow execution process 700 proceeds to block 730 where the execution or analysis calculation state is executed using the parameters 1004 of the workflow. Afterwards, the workflow execution process 700 proceeds to block 704. While the workflow execution process 700 is shown as ending if there are no more unexecuted states of the workflow 300, in some examples, the workflow execution process 700 may instead return to block 702.

FIG. 11 shows an example of a workflow GUI 1100 after data is imported and populated into its input fields 1106 (e.g., at block 720), and the focus moved to the next unfilled input field 1106 (e.g., at block 724). As shown, an eight digit number string has been populated into the part number input field 1106a. This is the same length number string as shown in the example workflow setup GUI 1000 of FIG. 10. However, the actual number data is different, reflecting the fact that the as the number data in the workflow setup GUI 1000 of FIG. 10 was just sample data. Likewise, the date in the manufacturing date input field 1106 is also different than the sample data in FIG. 10, and has been interpreted and/or translated by the system 100 from a strictly numerical format to a date (e.g., alphanumeric) format. As shown, the factory ID input field 1106c has a focusing highlight 1110 indicating that the focus has progressed from the part number and manufacturing date input fields 1106 after population.

FIG. 8 is a flowchart showing an example operation of the tag printing process 800 (i.e., the last block in the testing process 400 shown in FIG. 4). In some examples, the tag printing process 800 uses an inversion of the parsing rules 910 of a parsing configuration 250 (e.g., created and/or modified during the parsing configuration setup process 500) to combine several smaller data portions into one large data portion, and print a tag 136 encoding the one large data portion. While the tag printing process 800 is sometimes described below as conducting certain actions for the sake of understanding, it should be understood that one or more of the above described components of the material testing system 100 (e.g., the processing circuitry 224, UI 204, tag printer 150 etc.) may undertake the actions on behalf (and/or according to instructions) of the tag printing process 800.

In the example of FIG. 8, the tag printing process 800 begins at block 802 where a parsing configuration 250 and one or more parsing rules 910 of the parsing configuration 250 are selected. In some examples, the selection may be based on user input (e.g., received via the UI 204). For example, the user input may directly identify the parsing configuration 250 and/or parsing rules 910. As another example, the user input may indirectly identify the parsing configuration 250 and/or parsing rules 910, such as, for example, by identifying input fields 1106 mapped to the parsing rules 910, and/or by identifying a workflow state associated with the input fields 1106. In some examples, the tag printing process 800 may be limited to parsing configurations 250 and/or parsing rules 910 that handle numerical strings or (e.g., alphanumeric) character strings.

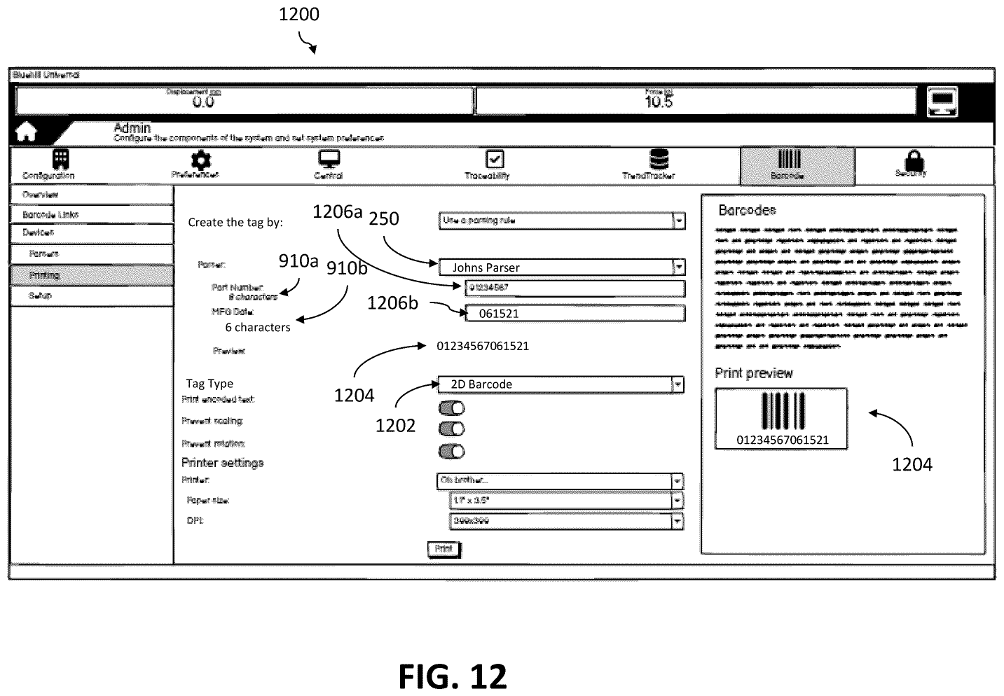

After block 802, the tag printing process 800 proceeds to block 804, where a type of tag 136 to print is selected. In some examples, the selection may be based on user input (e.g., received via the UI 204). For example, the user input may directly identify the type of tag 136 (e.g., 1D barcode tag 136a, 2D barcode tag 136b, NFC tag 136d, RFID tag 136e, etc.) via a tag printing GUI 1204 (see, e.g., FIG. 12). In some examples, the tag printing process 800 may automatically select the type of tag 136 to print, such as, for example, based on a type of input and/or importation device 108 the selected parsing configuration 250 is designed to work with.

Once the parsing rules 910 and type of tag 136 are selected at blocks 802-804, the tag printing process 800 outputs input fields 1206 (e.g., via tag printing GUI 1200) that are mapped to the parsing rules 910, and that a user can populate (e.g., via the UI 204). In some examples, the tag printing GUI 1200 may make clear that the input fields 1206 correspond to the selected parsing rules 910, and/or identify how the data populated into the input fields 1206 will be combined together according to the parsing rules 910. After data is actually entered into the input fields 1206 (at block 810), the tag printing process 800 may verify (at block 812) that any entered data complies with expected formatting criteria (e.g., size, length, data type, etc.) associated with the input fields 1206, parsing configuration 250, and/or parsing rules 910. If there are any formatting discrepancies, the tag printing process 800 may attempt to identify expected formatting criteria for one or more input fields 1206 and/or mapped parsing configurations 250 to which the input data would comply at block 814 (similar to block 714). Afterwards, the tag printing process 800 outputs error notification(s) at block 816 (similar to that which is described above with respect to block 716), then returns to block 802.

If all the formatting is correct, then the tag printing process 800 combines the data together using an inversion of the parsing rules 910 at block 818. For example, if the parsing rules 910 define how to break up a four character piece of data into a three character portion and a one character portion, the tag printing process 800 may combine a three character input and a one character input together into a single combined piece of data in the same way. Finally, the combined data is encoded and printed as a barcode by the barcode printer 150 at block 820.

FIG. 12 is an example of a tag printing GUI 1200 that might be output by the tag printing process 800. As shown, the tag printing GUI 204 identifies the parsing configuration 250 and the parsing rules 910 that will be used to print the tag 136. The tag printing GUI 204 additionally identifies a tag type 1202 to be printed, and shows several previews 1204 of the tag 136 that will be printed.

The disclosed material testing systems 100 allow for customization of different parsing configurations 250 that parse and/or separate imported data into several smaller portions of data according to parsing rules 910 of the parsing configuration 250. The systems 100 further allow for different parsing configurations 250 to be used for different workflows 300 (and/or different parts of the same workflow 300). In this way, a single piece of imported data can be used to set a value of several different workflow parameters 1004, and/or populate several different workflow input fields 1106. Additionally, the parsing rules 910 can be inverted to combine several smaller portions of data into one large piece of data, and print a tag 136 that encodes the large combined piece of data.

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” and/or “processing circuitry” means processing devices, apparatus, programs, circuits, components, systems, and subsystems, whether implemented in hardware, tangibly embodied software, or both, and whether or not it is programmable. The term “processor” and/or “processing circuitry” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor and/or processing circuitry may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory circuitry” means computer hardware or circuitry to store information for use by a processor and/or other digital device. The memory and/or memory circuitry can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

What is claimed is:

1. A material testing system, comprising:
a material testing machine comprising a test sensor, a test actuator, and a test controller configured to control the test actuator to conduct a test method; and
a non-transitory computer readable medium comprising machine readable instructions which, when executed by a processor, cause the processor to:
execute a material testing workflow configured to guide a user through setup, execution, or analysis of the test method of the material testing machine,
in response to executing the material testing workflow, display, on a display screen, a first graphical user interface (GUI) associated with a first workflow state of the material testing workflow, the first GUI comprising a first plurality of input fields,
identify one or more first input fields, of the first plurality of input fields, that are associated with at least one input field mapping,
the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields, and
in response to receiving a piece of data imported from a data importation device:
separate the piece of data into the two or more data portions according to the one or more parsing rules of the parsing configuration, and
populate the one or more first input fields based on the at least one input field mapping.

2. The system of claim 1, wherein the non-transitory computer readable medium further comprises machine readable instructions which, when executed by the processor, cause the processor to: during execution of the material testing workflow, use data populating the one or more first input fields to execute the test method on the material testing machine or analyze a result of the test method executed on the material testing machine.

3. The system of claim 1, wherein the non-transitory computer readable medium further comprises machine readable instructions which, when executed by the processor, cause the processor to:
in response to initiation of a parsing configuration setup process:
provide, via the display screen, a second GUI through which a user can customize the parsing configuration,
receive a first signal from one or more input devices of a user interface, the first signal being representative of a first user interaction with the second GUI, the first user interaction defining at least one parsing rule of the one or more parsing rules, and
create or modify, in the non-transitory computer readable medium, based on the first user interaction, machine readable data representative of the parsing configuration and the one or more parsing rules.

4. The system of claim 3, wherein the non-transitory computer readable medium further comprises machine readable instructions which, when executed by the processor, cause the processor to:
during the parsing configuration setup process, receive sample data imported from the data importation device,
display, on the display screen, a representation of the sample data in the second GUI, the first user interaction with the second GUI comprising an interaction with the representation of the sample data displayed in the second GUI, and
display, on the display screen, an annotation of the representation of the sample data in the second GUI in response to the first user interaction, the annotation being descriptive of the at least one parsing rule.

5. The system of claim 4, wherein the non-transitory computer readable medium further comprises machine readable instructions which, when executed by the processor, cause the processor to:
in response to initiation of a material testing workflow setup process:
provide, via the display screen, a third GUI through which a user can setup the material testing workflow,
receive a second signal from the one or more input devices, the second signal being representative of a second user interaction with the third GUI, the second user interaction defining the at least one input field mapping associated with the one or more first input fields of the material testing workflow, and
create or modify, in the non-transitory computer readable medium, the material testing workflow and the at least one input field mapping based on the second user interaction.

6. The system of claim 1, wherein the non-transitory computer readable medium further comprises machine readable instructions which, when executed by the processor, cause the processor to:
receive, via one or more input devices of a user interface, two or more user created data portions,
combine the two or more user created data portions into one user created data portion using an inversion of the one or more parsing rules of the parsing configuration, and
print, via a tag printer, a tag encoding the one user created data portion.

7. The system of claim 1, wherein the parsing configuration comprises a first parsing configuration, the first parsing configuration being associated with one or more first expected formatting criteria, and the non-transitory computer readable medium further comprises machine readable instructions which, when executed by the processor, cause the processor to:
in response to receiving the piece of data imported from the data importation device, verify that the piece of data complies with the one or more first expected formatting criteria of the first parsing configuration,
in response to successfully verifying that the piece of data complies with the one or more first expected formatting criteria of the first parsing configuration, separate the piece of data into the two or more data portions and populate the one or more first input fields, and
in response to unsuccessfully verifying that the piece of data complies with the one or more expected formatting criteria of the first parsing configuration, output a notification via the user interface or identify a second parsing configuration comprising second expected formatting criteria to which the piece of data complies.

8. A material testing system, comprising:
a data importation device;
a material testing machine, comprising:
a test sensor, a test actuator, and a test controller configured to control the test actuator to conduct a test method;
a user interface; and
a computing device configured for communication with the user interface, the material testing machine, and the data importation device, the computing device comprising:
processing circuitry configured to:
execute a material testing workflow configured to guide a user through setup, execution, or analysis of the test method of the material testing machine,
in response to executing the material testing workflow, display, on a display screen of the user interface, a first graphical user interface (GUI) associated with a first workflow state of the material testing workflow, the first GUI comprising a first plurality of input fields,
identify one or more first input fields, of the first plurality of input fields, that are associated with at least one input field mapping,
the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields, and
in response to receiving a piece of data imported from the data importation device:
separate the piece of data into the two or more data portions according to the one or more parsing rules of the parsing configuration, and
populate the one or more first input fields based on the at least one input field mapping.

9. The system of claim 8, wherein the data importation device comprises a barcode reader, a radio frequency identification (RFID) reader, a near field communication (NFC) reader, a short range ultra-high radio frequency reader, a camera, or a measuring device configured to measure a dimension of a specimen.

10. The system of claim 8, wherein the processing circuitry is further configured to:
in response to initiation of a parsing configuration setup process:
provide, via the display screen, a second GUI through which a user can customize the parsing configuration,
receive sample data imported from the data importation device,
display, on the display screen, a representation of the sample data in the second GUI,
receive a first signal from one or more input devices of the user interface, the first signal being representative of a first user interaction with the representation of the sample data displayed in the second GUI, the first user interaction defining at least one parsing rule of the one or more parsing rules, and
display, on the display screen, an annotation of the representation of the sample data in the second GUI in response to the first user interaction, the annotation being descriptive of the at least one parsing rule.

11. The system of claim 10, wherein the at least one parsing rule comprises a start location and character length of a sub-string of the two or more data portions, a particular character that occurs before or after the sub-string, a particular character string that occurs before or after the sub-string, or a number of portions into which to separate the piece of imported data.

12. The system of claim 10, wherein the processing circuitry is further configured to:
in response to initiation of a material testing workflow setup process:
provide, via the display screen, a third GUI through which a user can setup the material testing workflow,
receive a second signal from the one or more input devices, the second signal being representative of a second user interaction with the third GUI, the second user interaction defining the at least one input field mapping associated with the one or more first input fields of the material testing workflow, and
create or modify, in the memory circuitry, the material testing workflow and the at least one input field mapping based on the second user interaction.

13. The system of claim 12, wherein the processing circuitry is further configured to:
during the material testing workflow setup process,
in response to receiving one or more third signals from the one or more input devices, define the first workflow state of the material testing workflow and a second workflow state of the material testing workflow, the second workflow state being associated with a fourth GUI and a second plurality of input fields.

14. The system of claim 8, further comprising a tag printer in communication with the computing device, wherein the processing circuitry is further configured to:
receive, via the one or more input devices, two or more user created data portions,
combine the two or more user created data portions into one user created data portion using an inversion of the one or more parsing rules of the parsing configuration, and
print, via the tag printer, a tag encoding the one user created data portion.

15. A method, comprising:
executing, via processing circuitry of a computing device, a material testing workflow configured to guide a user through setup, execution, and analysis of a test method of a material testing machine, the computing device being in communication with the material testing machine, the material testing machine comprising a test sensor, a test actuator, and a test controller configured to control the test actuator to conduct a test method;
in response to executing the material testing workflow, displaying, on a display screen of the user interface, a first graphical user interface (GUI) associated with a first workflow state of the material testing workflow, the first GUI comprising a first plurality of input fields, and the user interface being in communication with the computing device;
identifying, via the processing circuitry, one or more first input fields, of the first plurality of input fields, that are associated with at least one input field mapping,
the at least one input field mapping specifying a parsing configuration, of a plurality of stored parsing configurations, that should be used with the one or more first input fields, the parsing configuration comprising one or more parsing rules according to which a piece of imported data can be separated into two or more data portions, the at least one input field mapping further specifying which of the two or more data portions parsed according to the one or more parsing rules should be used to populate the one or more first input fields; and
in response to receiving, at the computing device, a piece of data imported from a data importation device in communication with the computing device:
separating the piece of data into the two or more data portions according to the one or more parsing rules of the parsing configuration, and
populating the one or more first input fields based on the at least one input field mapping.

16. The method of claim 15, wherein the data importation device comprises a barcode reader, a radio frequency identification (RFID) reader, a near field communication (NFC) reader, a short range ultra-high radio frequency reader, a camera, or a measuring device configured to measure a dimension of a specimen.

17. The method of claim 15, further comprising using data populating the one or more first input fields to execute the test method on the material testing machine, or analyze a result of the test method executed on the material testing machine, during execution of the material testing workflow.

18. The method of claim 15, further comprising:
in response to initiation of a parsing configuration setup process:
providing, via the display screen, a second GUI through which a user can customize the parsing configuration,
receiving, at the computing device, sample data imported from the data importation device,
displaying, on the display screen, a representation of the sample data in the second GUI,
receiving, at the computing device, a first signal from one or more input devices of the user interface, the first signal being representative of a first user interaction with the representation of the sample data displayed in the second GUI, the first user interaction defining at least one parsing rule of the one or more parsing rules,
displaying, on the display screen, an annotation of the representation of the sample data in the second GUI in response to the first user interaction, the annotation being descriptive of the at least one parsing rule, and
creating or modifying, in memory circuitry of the computing device, the parsing configuration and the one or more parsing rules based on the first user interaction.

19. The method of claim 15, further comprising:
receiving, at the computing device, via the one or more input devices, two or more smaller user created data portions;
combining, via the processing circuitry, the two or more smaller user created data portions into one larger user created data portion using an inversion of the one or more parsing rules of the parsing configuration; and
printing, via a tag printer in communication with the communication device, a tag encoding the one larger user created data portion.

20. The method of claim 15, wherein the parsing configuration comprises a first parsing configuration, the first parsing configuration being associated with one or more first expected formatting criteria, the method further comprising:
in response to receiving, at the computing device, the piece of data imported from the data importation device, verify, via the processing circuitry, that the piece of data complies with the one or more first expected formatting criteria of the first parsing configuration,
in response to successfully verifying that the piece of data complies with the one or more first expected formatting criteria of the first parsing configuration, separate the piece of data into the two or more data portions and populate the one or more first input fields, and
in response to unsuccessfully verifying that the piece of data complies with the one or more expected formatting criteria of the first parsing configuration, output a notification via the user interface or identify a second parsing configuration comprising second expected formatting criteria to which the piece of data complies.
